(19) United States
(12) Patent Application Publication
(10) Pub. No.: US 2012/0111901 A1
(43) Pub. Date: May 10, 2012

(54) DRIP RESISTANT DISPENSING VALVE FOR FLUIDS

(75) Inventors: Daniel Beard, Hinsdale, IL (US); Kevin Totten, South Elgin, IL (US); Charles Webster, Sugar Grove, IL (US)

(73) Assignee: International Dispensing Corporation, Millersville, MD (US)

(21) Appl. No.: 12/940,705

(22) Filed: Nov. 5, 2010

(51) Int. Cl. B67D 7/06

(52) U.S. Cl. 222/511

(57) ABSTRACT

A drip resistant dispensing valve for fluids is disclosed, which provides a dispensing outlet configured to minimize the tendency for residual fluid to collect in and drip from the dispensing outlet while maintaining a simple construction for ease of manufacture. The dispensing outlet face is situated a distance away from the valve body, which tends to prevent, or at least minimize the risk of, contact between potentially contaminating external surfaces with the surfaces of the discharge outlet. Such construction assists in minimizing the retention of fluid on the surfaces of the dispensing outlet, and migration of the fluid to surfaces outside of the dispensing outlet that could tend to promote growth of biological contaminates and/or provide additional surfaces that could pool fluid following a dispensing operation and thereafter drip from the valve. A shell is provided around the dispensing outlet to assist in avoiding contamination of the valve and of the fluid being dispensed through the valve, and to aid in positioning a receptacle for receiving fluid from the dispensing valve.

### BACKGROUND OF THE INVENTION

1. Field Of The Invention

The present invention relates to fluid dispensing apparatus and, more particularly, to a robust, relatively simple, low-cost, and easily actuatable dispensing valve for dispensing fluid from a source of such fluid, which valve is configured so as to reduce the tendency for residual fluid to collect on and ultimately drip from the valve following a dispensing operation, and to minimize the risk of contamination of the valve and the fluid that is to be dispensed.

2. Description Of The Background

Dispensing valves for dispensing fluid from fluid containers, systems, or other sources of such fluid are shown by U.S. Pat. Nos. 3,187,965; 3,263,875; 3,493,146; 3,620,425; 4,440,316; 4,687,123; 5,918,779; 6,491,189; and 6,742,680. Such valves can be used, for example, in a system for dispensing beverages or other liquids used by consumers in the home. Low cost, trouble-free, and reliable valve action are significant considerations in these applications. Low cost is particularly important if the valve is to be sold as a disposable item as, for example, where the valve is provided attached to a filled fluid container and discarded along with the container when the fluid has been consumed.

Unfortunately, many of the dispensing valve mechanisms available fail to provide a dispensing outlet that does not avoid the collection of liquid on its surfaces, thereby resulting in the unwanted release of liquid from the dispensing outlet after it has been shut off. For instance, during a dispensing operation, fluid from a storage container typically contacts the inside surfaces of a dispensing outlet on a dispensing valve. These inner surfaces can tend to collect liquid during use of the dispensing valve, such that after fluid is dispensed and the user has removed the cup, glass, or other receptacle for receiving the liquid and released the actuation mechanism of the dispensing valve, the collected liquid on the inner surface remains. Thus, not all of the liquid is caught in the receptacle; rather, some accumulates on such inner surfaces and may drip off such surfaces after the dispensing operation.

Still further, many of the currently employed dispensing valves promote the development of unsanitary conditions in and around the dispensing outlet. This may be due to the configuration of the dispensing outlet, which allows direct contact between the outlet and the user or the receptacle employed by the user. Through such direct contact with the dispensing outlet, various bacteria, pathogens, and the like may be transmitted to the surfaces of the dispensing outlet. Many such pathogens and the like may not be readily ascertainable through visual inspection and may survive cleaning of the dispensing outlet. This may lead to such unwanted organisms traveling further into the dispensing valve, and likewise into a container to which the dispensing valve is attached and contaminating the liquid within.

In U.S. Pat. No. 3,187,965 to Bourget, a dispensing valve for a milk container is shown having a generally integral valve body connected at one end to the milk container. The valve body has an L-shaped passage formed therein defining an inlet opening at one end in communication with the milk container and a discharge outlet at the opposite end for discharging the milk to the exterior of the container when the valve is opened using a push-button actuator. The discharge outlet is fully exposed to the outside environment, thus promoting contact with potentially contaminated surfaces, and no provision is made to prevent residual undispensed fluid from collecting in and/or dripping from the discharge outlet.

Another valve, shown in U.S. Pat. No. 3,263,875 to Lofdahl, has a similarly configured dispensing outlet and a push-button actuator, and once again lacks any provision to prevent residual undispensed fluid from collecting in and/or dripping from the discharge outlet, and fully exposes the discharge outlet to the outside environment, thus promoting contact with potentially contaminated surfaces.

Likewise, commercial attempts have been made to provide low-cost dispensing valves for use with disposable containers, but such efforts have met with limited success. For example, Waddington & Duval Ltd. provide a press tap for use with disposable containers (such as wine boxes, water bottles, and liquid laundry detergent containers) under model designations COM 4452 and COM 4458, both of which provide a depressible button actuator operatively connected to a valve closure for moving the valve closure away from a valve seat to dispense fluid through a discharge outlet. As with the examples provided above, the discharge outlet is fully exposed to the outside environment, thus promoting contact with potentially contaminated surfaces, and no provision is made to prevent residual undispensed fluid from collecting in and/or dripping from the discharge outlet.

Similarly, the Jefferson Smurfit Group provides a similar tap for use with disposable containers under the model designation VITOP. Once again, the Jefferson Smurfit Group tap construction is configured such that the discharge outlet is fully exposed to the outside environment, thus promoting contact with potentially contaminated surfaces, and no provision is made to prevent residual undispensed fluid from collecting in and/or dripping from the discharge outlet.

Moreover, such valve constructions are configured such that undispensed fluid will remain in the valve behind the valve seat after use in a significant portion of the valve body and away from the container to which such valve is attached (and likewise away from any refrigerated environment in which such container is stored). This increases the risk of spoilage of such volume of fluid resting within the valve body after each use. Still further, such valve constructions lack the physical integrity to withstand vigorous sterilization procedures required of many fluid dispensing applications, including irradiation at exposures of up to as high as 5.0 MRAD and high temperature steam and chemical sterilization procedures.

Thus, although substantial effort has been devoted in the art towards development of low-cost valves of this general type, there remains an unmet need for a disposable valve having a discharge outlet that reduces the tendency for residual fluid to collect in and drip from the dispensing outlet while maintaining a simple construction for ease of manufacture, and that exhibits a configuration that tends to prevent, or at least minimize the risk of, contact between potentially contaminating external surfaces with the surfaces of the discharge outlet. Likewise, there remains an unmet need for a dripless valve that is easier to use than prior known valves and that does not require that the user exert large forces to hold the valve open. This problem is complicated by the fact that the tendency of a spring or other resilient member to maintain the valve in a closed position should provide the force necessary to assure leak-free seating of the valve seal when in such closed position Likewise, there remains an unmet need for a disposable valve that is sufficiently robust so as to be able to withstand vigorous sterilization procedures, that reduces heat transfer through the valve between the interior and exterior of the fluid container, and that does not trap a significant amount of fluid outside of the intended storage vessel between dispensing cycles.

### SUMMARY OF THE INVENTION

It is, therefore, an object of the present invention to provide a fluid dispensing valve that avoids the disadvantages of the prior art.

Accordingly, the present invention provides a drip resistant dispensing valve including a discharge mechanism having decreased liquid retention properties. Further, the discharge mechanism of the drip resistant dispensing valve provides an outer shell that promotes the avoidance of direct contact between a user and/or receptacle and the dispensing outlet.

It is another object of the present invention to provide a fluid dispensing valve that is drip resistant and avoids the unwanted accumulation of liquids outside of the liquid container to which the valve is attached.

It is a further object of the present invention to provide a fluid dispensing valve that promotes the avoidance of contaminants contacting and/or inhabiting the dispensing outlet, other interior surfaces of the dispensing valve, and/or the liquid container.

Disclosed herein is a drip resistant dispensing valve for fluids that provides for ease of use by requiring only a minimal force exerted on the valve actuator to maintain the valve in an open position, and that offers a simple, ergonomic design and robust functionality capable of dispensing a wide variety of products.

With regard to a first aspect of a particularly preferred embodiment, a valve includes a discharge mechanism having properties that reduce or eliminate the propensity for residual fluid to remain on such discharge mechanism following a discharge or dispensing operation. The discharge mechanism provides an outer shell that promotes the avoidance of direct contact between a user, a receptacle, and/or other potentially contaminating surfaces and the dispensing outlet of the discharge mechanism.

With regard to another aspect of a particularly preferred embodiment, the valve body and actuator are formed of a polypropylene copolymer with an average wall thickness of approximately 0.06 inches, and the valve seal is formed of a thermoplastic rubber having an average thickness of about 0.03 inches. Such dimensional characteristics and materials allow the drip resistant dispensing valve to withstand the highest aseptic sterilization regimen as outlined by the Food & Drug Administration (FDA) and maintain the sterility of a product as specified by the National Sanitation Foundation (NSF) guidelines. More specifically, the dispensing apparatus is able to withstand either gamma or cobalt irradiation at the maximum dose of 5.0 MRAD (50 Kilogray) in the sterilization process. The dispensing apparatus is able to withstand the high temperatures associated with the steam and chemical sterilization processes required in the filling process. The dispensing apparatus is capable of withstanding these combined sterilization regimens without degrading the valve structure or operation. Thus, the valve of the instant invention may be used to dispense products ranging from aseptic products such as dairy, 100% juice and soy products, to commercially sterile products such as preserved juice and coffee products, to non-sterile fluids such as chemical solvents.

In order to allow a minimal force for holding the valve in an open position, a resilient valve actuator having the characteristics of a nonlinear spring is provided at an actuator end of the valve body and operatively connected to a plunger, with the opposite end of the plunger having mounted thereon a resilient valve seal. An intermediate discharge outlet is positioned between the actuator end and the valve seal, such discharge outlet being placed in fluid communication with the interior of a fluid container to which the valve is attached when the valve is in an open position. A valve port wall is positioned between the valve seal and the dispensing chamber providing a plurality of ports for controlling the flow of fluid through the valve body when the valve is in an open position. The valve and the valve port wall are positioned such that when the valve is installed on a liquid container, virtually no liquid will be trapped by the valve structure outside of the insulated container, thus preventing the spoilage of a dose of liquid resting in the valve after each dispensing cycle. A push-button is provided for actuating the drip resistant dispensing valve and is exposed to the exterior of a fluid container to which the drip resistant dispensing valve is attached. In one embodiment of the instant invention, the push-button is concentrically mounted within a breakaway circular rim. Upon first using the drip resistant dispensing valve, a user depresses the push-button, dislodging the circular rim from the button, and thereby providing evidence that the valve had been opened, thus providing a tamper-evident actuator.

Such valve is also preferably configured so as to withstand sterilization procedures including irradiation up to 5.0 MRAD and high temperature steam and chemical sterilization processes without degradation of the integrity of the valve structure or operation, and thus may be used for dispensing a wide variety of products ranging from aseptic products (free from microorganisms) to non-sterile products.

The simplicity and functionality of the drip resistant dispensing valve of the instant invention enables its manufacture and automatic assembly with multiple cavity tools, which in turn reduce manufacturing costs, and offers the market a low cost dispensing solution. The simplicity and functionality of the design also enables the dispensing apparatus to be easily customized in the manufacturing process to fit a wide range of dispensing packages such as a flexible pouch, flexible bag, or semi-rigid plastic container. The drip resistant dispensing valve of the instant invention is also configured to adapt easily to a wide range of filling machines and filling conditions worldwide.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is an exploded view of a drip resistant dispensing valve in accordance with an exemplary embodiment of the present invention;

FIG. 2 is an expanded partial cut-away view illustrating the drip resistant dispensing valve shown in FIG. 1;

FIG. 3 is a side view illustrating the dispensing outlet of the drip resistant dispensing valve shown in FIG. 1;

FIG. 4 is a cut-away view of the drip resistant dispensing valve taken along line ‘A-A’ of FIG. 3;

FIG. 5 is an enlarged view of FIG. 4, showing the valve plunger, actuator, and seal;

FIG. 6 is a side view illustrating a sanitary cover for the dispensing outlet of the drip resistant dispensing valve shown in FIG. 1;

FIG. 7 is a top view illustrating the actuation end of the drip resistant dispensing valve shown in FIG. 1;

FIG. 8 is a cut-away view of the drip resistant dispensing valve taken along line ‘B-B’ of FIG. 7;

FIG. 9 is a bottom view illustrating the fluid inlet end of the drip resistant dispensing valve shown in FIG. 1;

FIG. 10 is a plan view of the valve seal shown in FIGS. 1, 2, and 5;

FIG. 11 is a cross-section of the valve seal taken along line ‘C-C’ of FIG. 10; and

FIG. 12 is a side cross-sectional view of an actuator for use with the drip resistant dispensing valve shown in FIG. 1.

### DETAILED DESCRIPTION OF PREFERRED EMBODIMENTS

The invention summarized above and defined by the enumerated claims may be understood by referring to the following description, which should be read in conjunction with the accompanying drawings in which like reference numbers are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

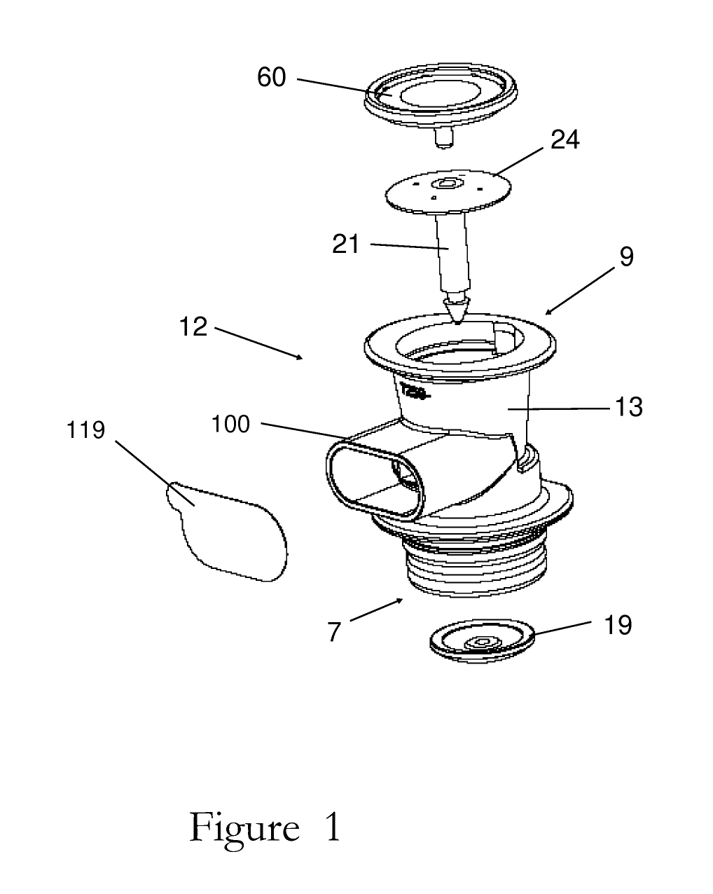

Referring to the drawings, FIG. 1 shows a drip resistant dispensing valve 12 in accordance with one embodiment of the present invention. As will be described in greater detail below, valve 12 is configured for attachment to a fluid container (not shown), which may be a rigid container (such as a thermos or plastic bottle), a flexible bag or pouch, or any other fluid container. The drip resistant dispensing valve 12 may be so situated on a fluid container so as to allow dispensing of fluid under gravity flow, or alternately, where the source of fluid is under a head of pressure, provided by a source other than gravity.

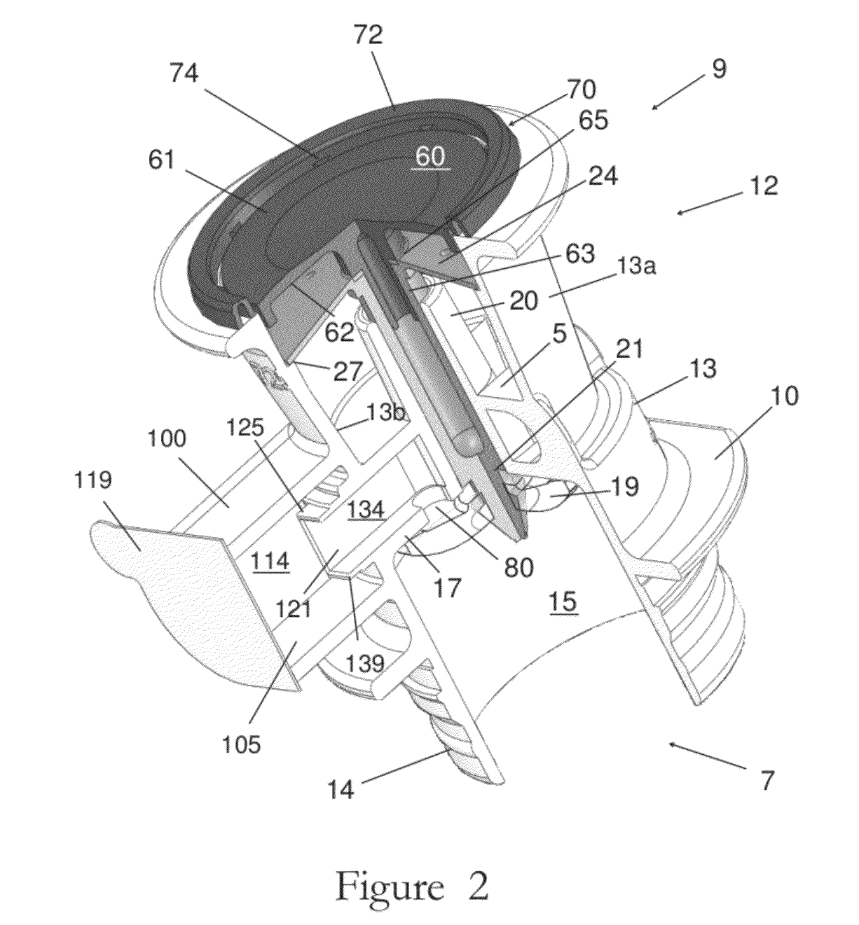

As is shown in the Figures, drip resistant dispensing valve 12 has a generally tubular valve body 13 having an outer wall 13a and an inner wall 13b. The valve body has an inner or inlet end 7, and an opposite outer or actuation end 9, and an axial direction extending between these ends. Although the valve body 13 is shown generally in the form of a round cylindrical tube, the valve body may be round, square, octagonal or other shape adapted for the application to which the drip resistant dispensing valve 12 will be applied. Alternately, only a portion of the valve body 13 may have such alternate shape, with the remainder of the valve body maintaining a generally cylindrical shape. For instance, inlet end 7 may have an oblong configuration where it connects to a fluid container, while the remainder of the valve body may maintain a generally cylindrical configuration. Valve body 13 is provided with features 14 for connecting the valve body 13 to a fluid container or other source of fluid to be dispensed so as to bring the inlet opening 15 (FIG. 2) formed in the valve body 13 in communication with the fluid to be dispensed. The particular connecting features 14 depicted in the drawings include ribs encircling the exterior of the valve body near the inlet end 7. These ribs are arranged to form a fluid-tight, press-fit connection between the exterior of the valve body and the interior of an outlet provided in the container. Other suitable connecting and sealing features may be used in addition to or in lieu of ribs. For example, the valve body 13 can be provided with threads or bayonet-type locking features that can be mated with features of the container. In addition, auxiliary sealing elements such as resilient O-rings or other gaskets can be provided on the container or on the valve body for engagement between the valve body and the container.

In a preferred embodiment, a discharge mechanism for the drip resistant dispensing valve 12 includes a shell 100 at least partially encompassing a discharge outlet 121. In a preferred embodiment, the shell 100 and discharge outlet 121 are integrally connected with or formed in the valve body 13 at a position between the inlet end 7 and actuator end 9. It is to be understood that shell 100 may be connected with valve body 13 through the use of various connection mechanisms, such as a threaded connection, compression lock connection, snap fit connection, friction fit connection, and the like. The shell 100 and discharge outlet 121 are disposed outside of the container or other source of fluid when the valve body 13 is engaged with the container. The shell 100 and discharge outlet 121 are generally in the form of a short tubular member extending in the direction perpendicular to the axial direction of the valve body. Discharge outlet 121 provides communication between an outside environment and the interior of the valve body 13.

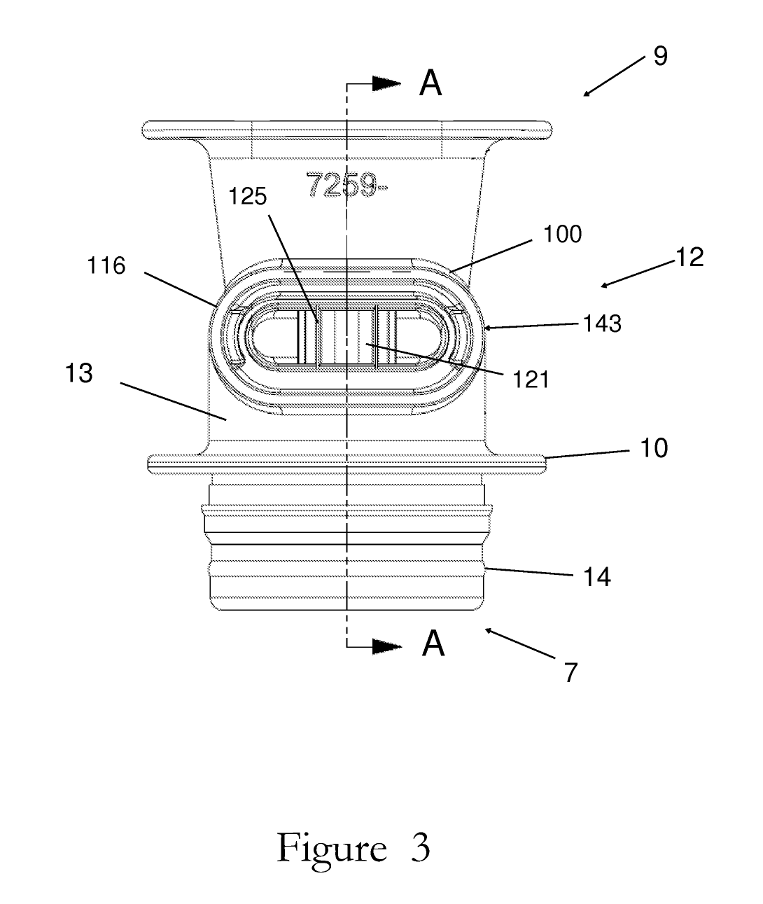

Discharge outlet 121 is configured so as to prohibit fluid being dispensed from outlet 121 from coming into contact with and/or collecting on the interior of shell 100. More particularly, discharge outlet 121 includes a wall 125 that forms a projecting surface extending from outer wall 13a of valve body 13 so as to direct all flow through an outlet channel 134. Discharge outlet 121 is configured to substantially prevent fluid from collecting on the interior surfaces of the outlet and remaining there following a dispensing operation. Fluid flowing through the outlet channel 134 may run along the interior of wall 125 of discharge outlet 121, but when it reaches the outer edge 139 of such discharge outlet 121, it has no path but to remain on the edge of the discharge outlet 121 or fall from the valve into a container into which the fluid is being dispensed. The wall 125 of discharge outlet 121 extends away from outer wall 13a, thus creating a distal separation between the open face 140 of discharge outlet 121 and the interior, back wall of shell 100 (formed by the outer wall 13a of the body). As shown in FIGS. 2-5, wall 125 of discharge outlet 121 forms a small rectangular opening at the open face 140 of the outlet channel 134. In the current embodiment, the rectangular opening is approximately 0.23 inches on each side. To promote a dripless feature, the wall 125 of the discharge outlet 121 should be as thin as possible (consistent with good molding practices), and should extend outward from the outer wall 13a of valve body 13 a distance that is at least three times the thickness of the outer edge 139 of the wall 125, and will preferably extend outward from the outer wall 13a a distance greater than three times the thickness of the outer edge 139 of the wall 125. The distal separation between the outer edge 139 at the open face 140 of the outlet channel 134 and the outer wall 13a of the valve body 13 prevents fluid being dispensed through discharge outlet 121 from contacting the inner surfaces of shell 100, as the fluid is unable, on its own, to traverse the 180 degree turn that would be necessary in order to migrate to those interior surfaces of shell 100. In this manner, residual undispensed fluid cannot pool on the inner surfaces of shell 100 and later drip off those surfaces at an undesirable time. Therefore, contamination of the interior of shell 100 (and establishment of sites on those surfaces at which biological contaminates might grow) is minimized, if not prevented altogether.

In the current embodiment, shell 100 is configured in a flat, generally cylindrical shape having an inner surface 105. Alternative configurations for shell 100 may be employed, such as in the shape of a square, rectangle, other polygonal shapes, or as a cylinder, oval, oblong, and other shapes as contemplated by those of ordinary skill the art, without departing from the scope and spirit of the present invention.

Shell 100 further includes a shell channel 114 that provides an open passage through the interior of shell 100. The boundaries of the shell channel 114 are defined by the shell inner surface 105. In a preferred embodiment, the shell channel 114 defines the open passage through shell 100 that surrounds the discharge outlet 121. Shell channel 114, similar to shell 100, extends in a perpendicular direction from the axial direction of the valve body 13.

The length that the shell 100 extends from the outer wall 13a of valve body 13 may increase the ease with which a user may proximally locate a receptacle next to the shell 100 for receiving the dispensed liquid. Further, the size of shell channel 114 may promote the use of the drip resistant dispensing valve 12 with variously sized receptacles, such as cups, water bottles, and the like. For instance, the generally cylindrical shape of the shell 100 may allow for its insertion into the mouth of a water bottle. This may promote a decrease in the amount of “lost” liquid or spillage during operation of the drip resistant dispensing valve 12.

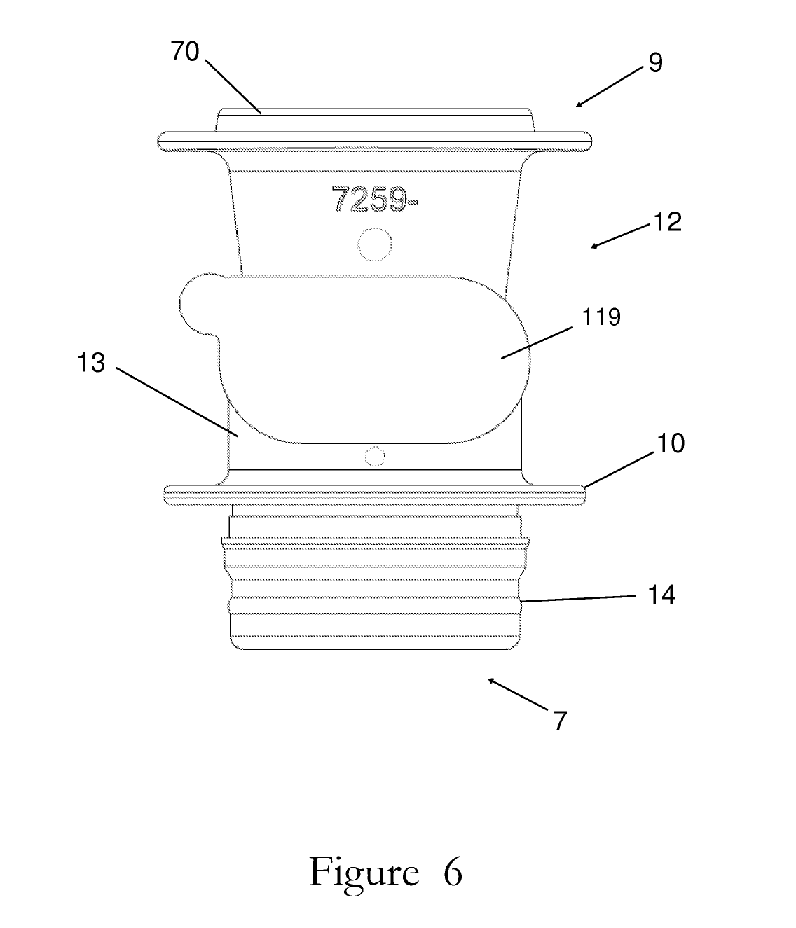

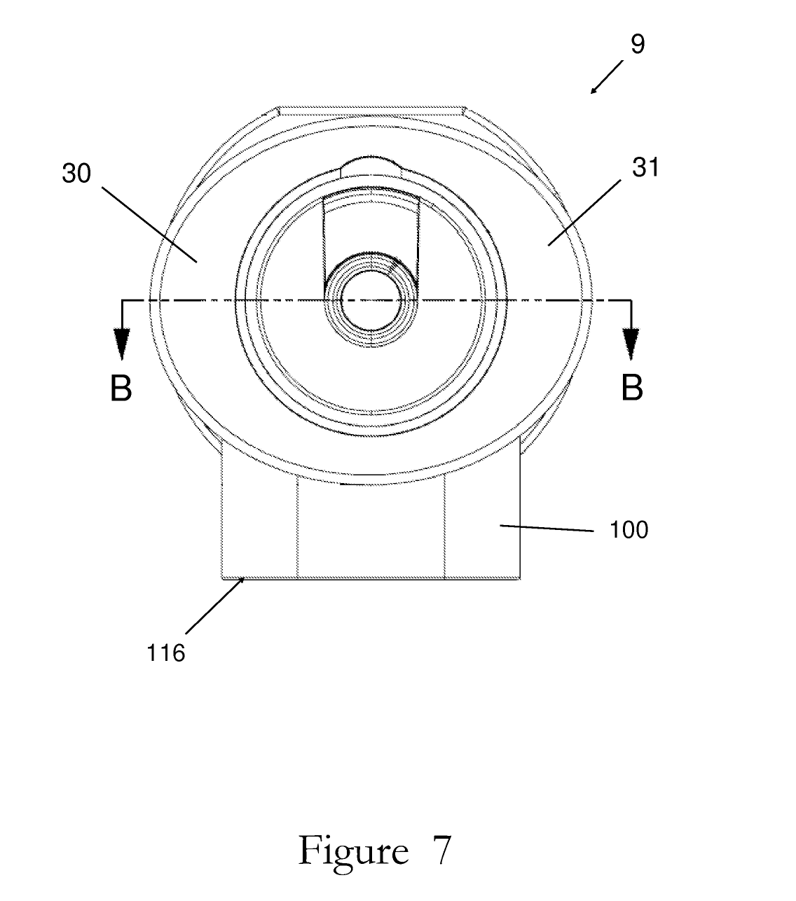

An outer edge 116, which is formed at the opposite end of shell 100 from its connection with the outer wall 13a of the valve body 13, preferably provides a generally flat surface. In some embodiments, the outer edge 116 may provide a concave surface. A removable cover 119, as best seen in FIG. 6, may be temporarily attached to the outer edge 116 during shipment of an unused, new valve 12. The cover 119 should be removed and disposed prior to use of the valve 12.

Further, shell 100 is configured to decrease the risk of contamination of the discharge outlet 121 and possibly a liquid within a container to which the drip resistant dispensing valve 12 may be attached. For instance, sufficient distance is provided between the outer edge 116 of shell 100 and the outer edge 139 at the open face 140 of the outlet channel 134 and laterally between the wall 125 of the discharge outlet 121 and the shell inner surface 105 to reduce the risk of contaminates on the outer edge 116 of the shell 100 traveling or migrating to the outer edge 139 of discharge outlet 121. Furthermore, the opening 143 at the end of shell channel 114 is substantially larger than the open face 140 of discharge outlet 121. Thus, the shell 100 provides a guard against the contamination of the discharge outlet 121 through its dimensional structure.

In operation, when a user activates the valve to dispense the liquid from within the container, fluid is discharged through channel 134 of the discharge outlet 121 in a manner that substantially prevents the liquid from contacting the inner surface 105 of the shell 100. Thus, while the shell 100 may promote the efficient use of the drip resistant dispensing valve 12 by providing an indicator to the user of where to locate a receptacle to receive the liquid during dispensing, it is generally not directly involved with the dispensing of the liquid itself. This may promote an environment on the inner surface 105 of the shell 100 capable of remaining substantially free from contaminates and/or as previously mentioned, assist in avoiding the travel of contaminates onto or into the discharge outlet 121 and outlet channel 134.

The thickness of the walls provided for the shell 100 and discharge outlet 121 may vary to accommodate the needs of various liquids and/or materials to be dispensed through drip resistant valve 12 connected to a container of the liquids/materials, so long as the construction maintains sufficient integrity to undergo the above-described sterilization and irradiation processes. In a preferred embodiment, the outer shell 100 and discharge outlet 121 have wall thicknesses of approximately 0.06 inches. The thickness of the walls assists in promoting the ease of operation and cleaning of the drip resistant valve 12 and the ability of the valve to be subjected to sterilization processes while maintaining its functionality.

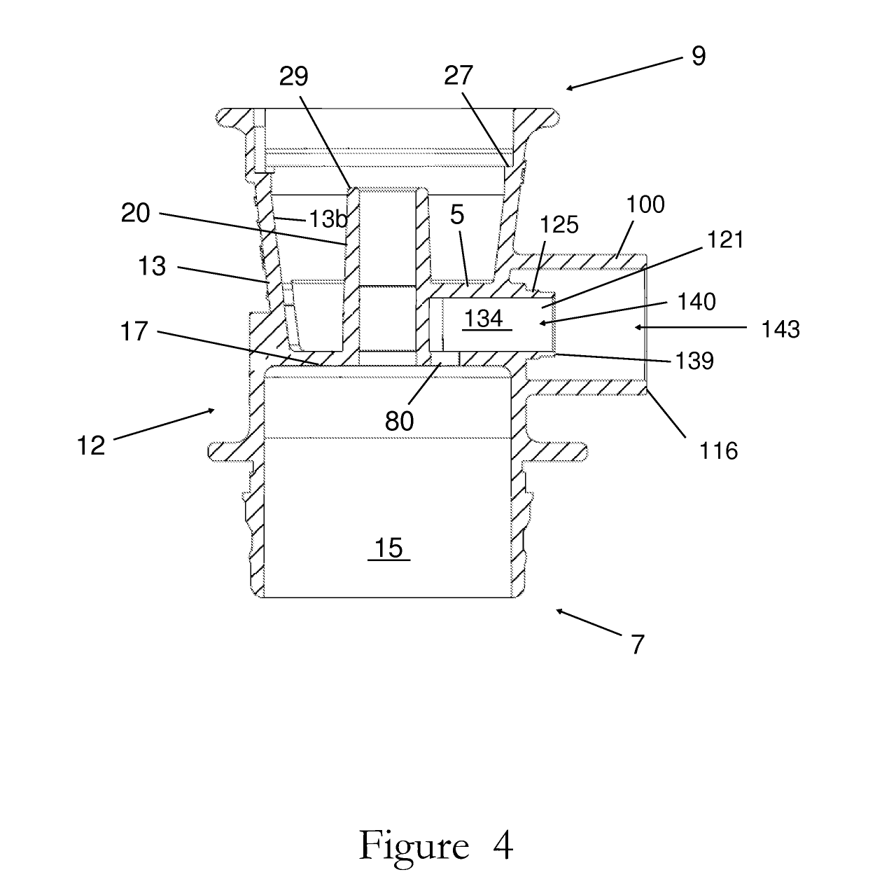

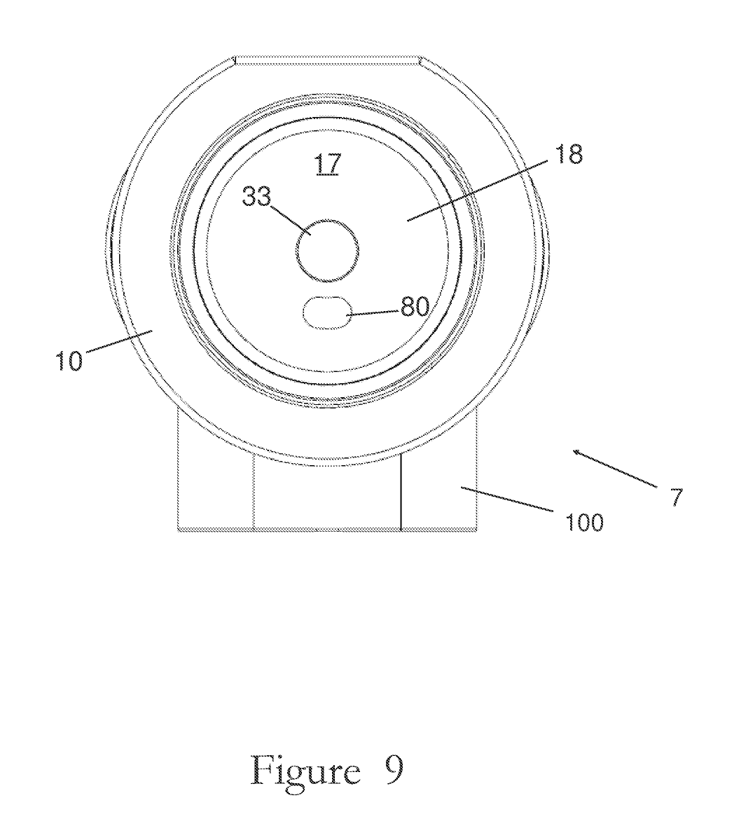

As shown more particularly in FIGS. 4, 5, 8 and 9, a valve port wall 17 extends across the interior of body 13 between inlet opening 15 and discharge outlet 121. The valve port wall 17 defines a at least one hole or valve port 80, as well as a valve seat 18 encircling the valve port 80 and facing toward the inlet opening 15. Preferably, the valve port 80 is located off the centerline of the valve port wall 17, toward the side of the valve body 13 from which the discharge outlet 121 extends. The fluid flow resistance of the valve 12 in the open position is controlled in large measure by the flow resistance of p valve port 80. Thus, the fluid flow resistance of the valve can be selected to fit the application by selecting the size of the valve port 80. The size of valve port 80 can be varied through only slight modification of injection molding apparatus (such as by varying movable pin positions within such a mold structure). This allows the manufacturer to make valves for almost any application with minimal tooling costs. Limited only by the size of discharge outlet 121, the valve port 80 need not be round or oval; other shapes, including an arcuate port extending partially around the center of the valve body and partially around plunger guide opening 33, can be made with appropriate interchangeable injection molding components.

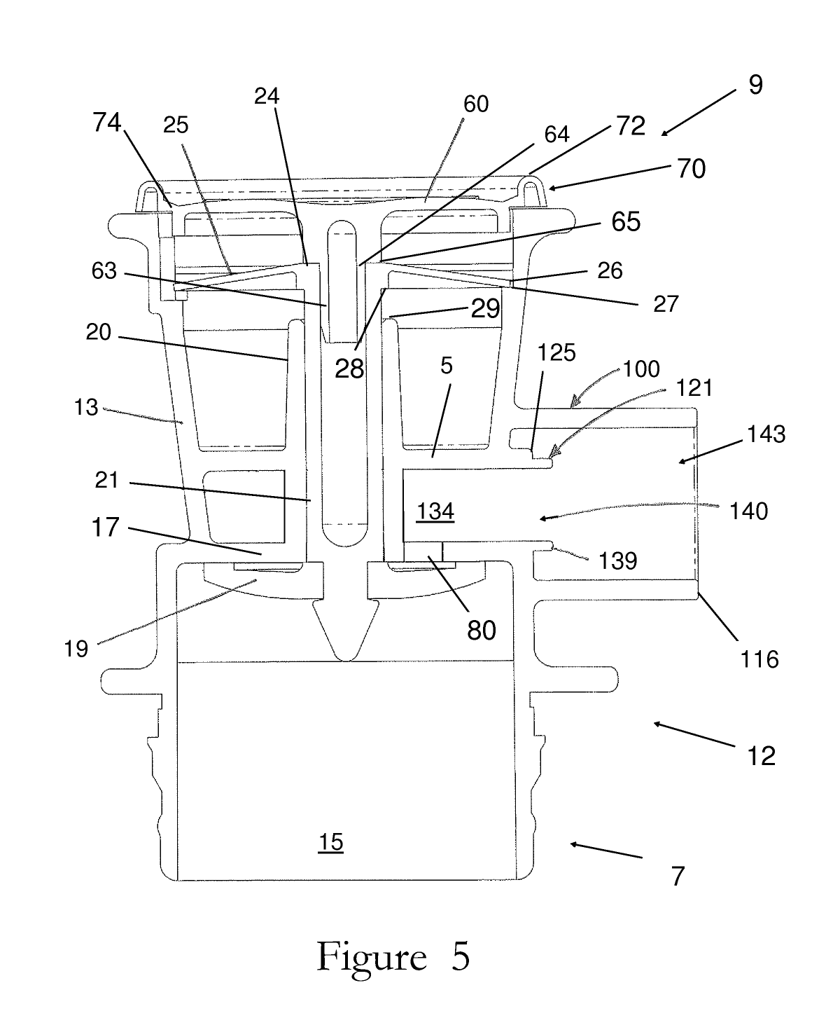

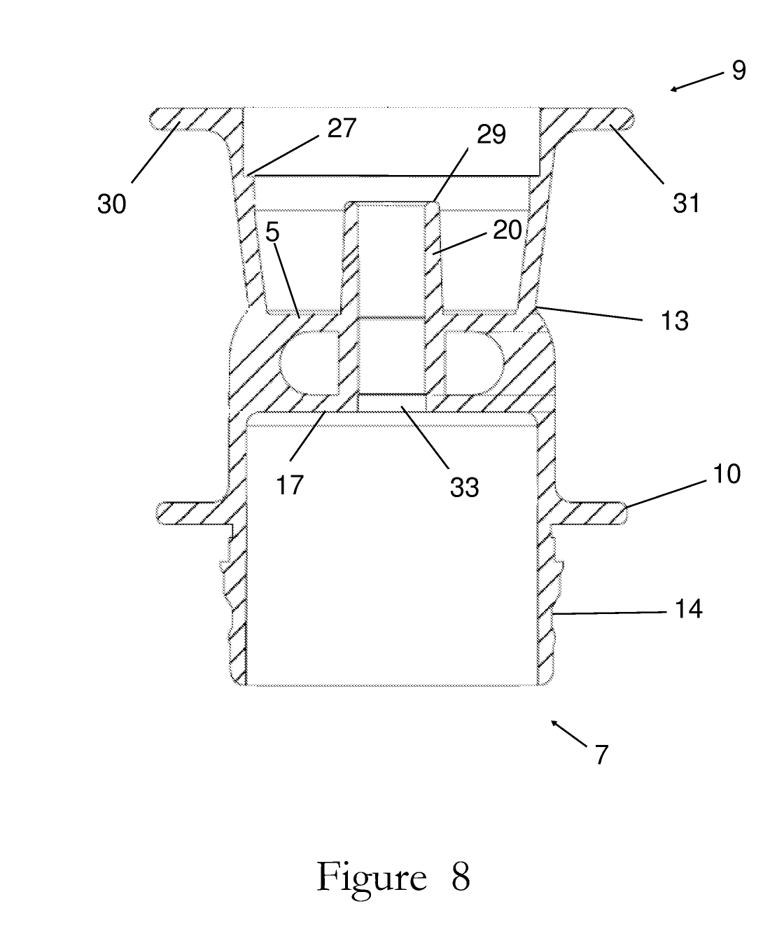

The valve port wall 17 also defines a plunger guide opening 33 adjacent the central axis of the valve body 13. A tubular plunger guide 20 extends outwardly from the valve port wall 17 toward the actuator end 9 of the valve body 13. The plunger guide 20 is aligned with the plunger guide opening 33 of the valve port wall 17. As best seen in FIGS. 5 and 8, a plunger guide support wall 5 extends across the valve body 13 just outward of discharge outlet 121, so that the plunger guide support wall 5 lies between the discharge outlet channel 134 and the actuator end 9 of the valve body 13. In the embodiment described herein, a portion of the plunger guide 20 combines with portions of the valve port wall 17 and the plunger guide support wall 5 to form boundaries for the discharge outlet channel 134.

The valve body 13 may also have a pair of grip wings 30 and 31 projecting outwardly from the remainder of the valve body 13 at actuator end 9. Grip wings 30 and 31 extend generally in directions perpendicular to the axial direction of the valve body and parallel to the direction of discharge outlet 121. Valve body 13 desirably is formed from a polymeric material compatible with the fluid to be dispensed as, for example, a thermoplastic such as polypropylene or other polyolefin. In a preferred embodiment, valve body 13 is formed from a polypropylene copolymer.

A plunger member 21 is slidably mounted in plunger guide 20. Plunger member 21 desirably is also made of polypropylene or other plastic material. In a preferred embodiment, plunger member 21 is likewise formed from a polypropylene copolymer.

Plunger member 21 has an inner end 22 that extends through the plunger guide 20 and through the plunger guide opening 33 of valve port wall 17 into the inlet opening 15. The plunger guide 20 also serves to separate the plunger member 21 from the discharge outlet 121.

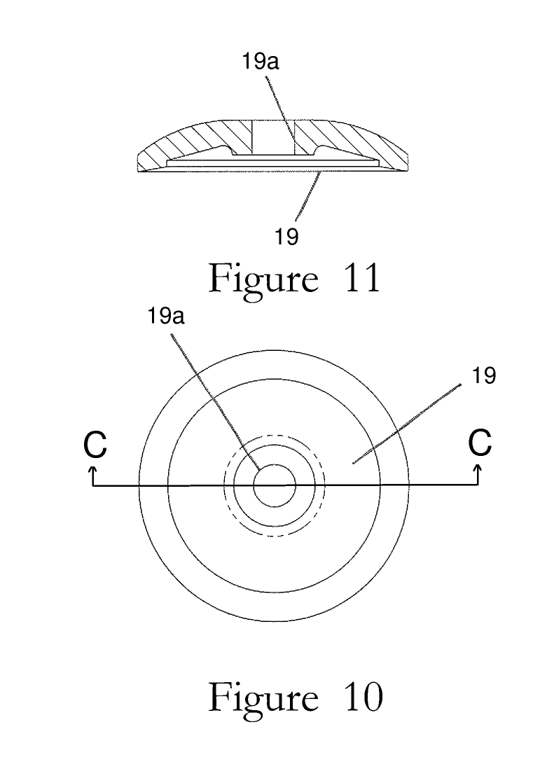

Referring to FIGS. 10, 11, and 12, a resilient valve seal 19 in the form of a shallow conical member is fixedly connected to the inner end 22 of the plunger member, as by a coupling element 22a that can be force fitted into engagement with a sized opening 19a in the valve seal 19 because of the resilient nature of the materials from which the valve seal 19 and plunger 21 are fabricated. Valve seal 19 can be formed from essentially any resilient material that will not react with or contaminate the fluid being dispensed, and that will not melt or degrade under the conditions encountered in service. For example, a thermoplastic or thermosetting elastomer or other flexible material, typically in the range of about 30 to about 80 Shore A durometer, and more preferably, about 50 to about 80 Shore A durometer, can be employed in typical beverage dispensing applications. In a preferred embodiment, valve seal 19 is formed from a thermoplastic rubber. The periphery of valve seal 19 overlies valve seat 18 and seals against the valve seat when the valve is in the closed position depicted in FIGS. 2 and 5.

The thickness of the valve seal 19 will depend on the material and operating conditions. Merely by way of example, in a valve for dispensing beverages under gravity head (e.g., on the order of 0.5 to 1 pound per square inch pressure), the valve seal is about 1 inch in diameter and about 0.020 to 0.040 inches thick, most preferably about 0.032 inches thick, at its periphery.

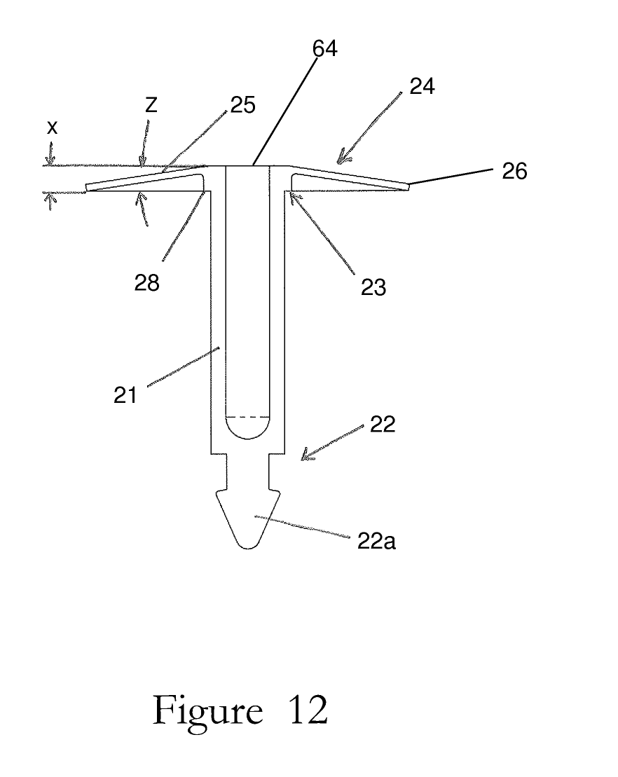

A cylindrical stop member 28 and actuator 24 are formed integrally with the plunger member 21 at the outer end 23 of plunger member 21 remote from the inner end 22. Actuator 24 has a dome-shaped resilient section 25, so sized that the perimeter 26 of this dome-shaped section 25 can be mounted or held from escaping by a ledge or groove 27 disposed on the inner wall 13b of the valve body 13, just inward of the actuator end 9 of the valve body 13. The dimensions of the actuator 24 are selected to provide desired resilient action and force/deflection characteristics as described in U.S. Pat. No. 6,491,189, the specification of which is incorporated herein by reference in its entirety. In one exemplary embodiment, the plunger 21, stop member 28, and actuator 24, including resilient section 25, are molded as a unit from polycarbonate or similar material. The resilient section 25 is generally conical and about 1 inch in diameter, with an included angle of about 160°. That is, the wall of the conical resilient section lies at an angle Z (FIG. 12) of 10° to the plane perpendicular to the axial direction of the plunger member 21. The resilient section 25 is about 0.012 inches thick at its perimeter, and about 0.018 inches thick at its juncture with stop member 28. Stop member 28 is about 0.292 inches in diameter. Thus, the ratio between the axial extent x of the conical resilient section and the average thickness of the resilient section is about 4:1.

Stop member 28 coacts with a stop shoulder 29 formed by the outer end of the plunger guide 20. Thus, the distance that the plunger 21 can be moved when force is exerted on the plunger 21 at actuator 24 will be determined by the distance the stop member 28 can travel before contact is made with the stop shoulder 29 (see FIG. 5).

A positioning flange 10 is preferably provided circumscribing the valve body 13 just above connecting features 14. When the drip resistant dispensing valve 12 is installed on a fluid container, positioning flange 10 abuts the exterior wall of the container. In its closed position (seated against the port wall 17), the valve seal 19 is positioned a short axial distance from positioning flange 10, preferably not more than about 0.25 inches, so as to limit the amount of fluid contained within the portion of the valve outside of the fluid container to the volume within the inlet end of the valve between positioning flange 10 and the valve seal 19. By limiting the amount of fluid that may be contained within the valve structure after a dispensing cycle, the risk of subjecting a dose of liquid held within the valve after a dispensing cycle to temperature fluctuations is reduced, in turn reducing the risk of dispensing a dose of spoiled liquid at the start of the following dispensing cycle.

In operation, the valve 12 is preferably mounted to a fluid container (not shown). The discharge opening preferably points downwardly outside of the container, whereas finger grip wings 30 and 31 project horizontally. The valve 12 normally remains in the fully closed position. In this position, the resilience of actuator 24 urges the plunger 21 outwardly, toward the actuator end 9 of the valve body 13, and holds the valve seal 19 in engagement with seat 18, so that the valve seal 19 blocks flow from the inlet opening 15 to port 80 and discharge outlet 121. In this condition, the pressure of the liquid in the container tends to force the valve seal 19 against seat 18, thereby closing the valve.

In the embodiment of the instant invention shown in FIGS. 2 and 5, a separate push button element 60 is provided for manual engagement by a user to operate the drip resistant dispensing valve 12. Push button element 60 is preferably formed as a disk having a generally planar top surface 61 and a bottom surface 62 on the opposite side from the top surface 61. Extending downward from and centrally located on bottom surface 62 is an engagement pin 63. In the embodiment of the instant invention depicted in FIGS. 2 and 12, the dome-shaped resilient section 25 of actuator 24 is provided with a central opening 64 sized to receive engagement pin 63 therein and to hold the engagement pin 63 in place via a friction fit. Thus, depressing push button element 60 downward likewise causes plunger member 21 and valve seal 19 to move in an opening direction aligned with the central axis of the valve body and transverse to valve port wall 17. Preferably, engagement pin 63 is provided a circumferential ledge 65 around pin 63 generally parallel to bottom surface 62. When inserted into actuator 24, pin 63 thus fits snugly within central opening 64 in actuator 24, while ledge 65 lies flush against the top face of actuator 24. Thus, when push button element 60 is pushed downward, only ledge 65 comes in contact with actuator 24, thus ensuring that the dome-shaped resilient section does not lose its shape or its spring characteristic when the button is actuated.

In an alternate embodiment of the instant invention, push button element 60 further comprises a detachable tamper indicating ring 70 circumscribing push button element 60. Tamper indicating ring 70 includes a flat surface sized and configured to seat against the actuation end 9 of the valve body 13 surrounding actuator 24. The tamper indicating ring 70 is provided with a plurality of tabs 74 extending towards the interior of the tamper indicating ring 70, each tab 74 having a narrow terminal section attached to the upper and outer edge of push button element 60. Tabs 74 are preferably configured so as to position push button element 60 substantially below the plane defined by the uppermost extent 72 of the tamper indicating ring 70, such that when push button element 60 is assembled with actuator 24 within the drip resistant dispensing valve 12, the outermost point of the actuation end 9 is the uppermost extent 72 of the tamper indicating ring 70. Thus, by recessing push button 60 into the structure of drip resistant dispensing valve 12 and below the uppermost extent 72 of the tamper indicating ring 70, inadvertent or accidental actuation of the valve (through bumping against a surface, etc.) may be averted.

In use, a new drip resistant dispensing valve 12 is provided on an unused container with push button element 60 installed in actuator 24 with tamper indicating ring 70 intact. Upon the first actuation of the valve through depression of push button 60, movement of tamper indicating ring 70 is blocked by the upper edge of valve body 13, such that movement of push button element 60 into valve body 13 results in breaking of tabs 74 and tamper indicating ring 70 separating from push button element 60. Thus, previous actuation of valve 12 may be readily apparent to a user based upon either the presence or absence of tamper indicating ring 70 from push button element 60.

The user can open the valve by grasping the finger grip wings 30 and 31 with his or her fingers and pressing his or her thumb against the center section of the push button element 60 so as to intentionally move actuator 24, plunger member 21, and valve seal 19 in an opening direction aligned with the central axis of the valve body and transverse to valve port wall 17. Such movement takes the plunger member 21 and valve seal 19 from the normally closed position towards an open position, in which stop member 28 on the plunger member 21 engages stop shoulder 29 on the plunger guide 20 of the valve body 13. In this open position, the valve seal 19 is remote from valve port wall 17 and remote from seat 18, so that the valve seal 19 does not occlude port 80 and hence fluid can flow from a container to outlet channel 134.

Because the finger gripping members 30 and 31 extend generally transverse to the discharge outlet 121, and extend generally horizontally during use of the valve, the user's fingers will be supported above the bottom end of the discharge outlet 121, out of the stream of fluid discharged from the opening. Thus, if a hot fluid is being dispensed, it will not harm the user.

By constructing each of the valve elements as discussed above, namely, forming the valve body from a polypropylene copolymer having a minimum average wall thickness of approximately 0.06 inches, and forming the valve seal from a thermoplastic rubber having an average thickness of about 0.03 inches, the valve structure may be subjected to the vigorous sterilization processes necessary for using the valve in food applications, including irradiating the structure at up to 5.0 MRAD and subjecting the structure to high temperature chemical and steam sterilization processes, without causing the valve structure to become brittle or otherwise jeopardizing the integrity of the valve's structure or operation.

Since the drip resistant dispensing valve 12 as above described is made with only a few parts formed by conventional, simple molding techniques, it is relatively simple in operation and inexpensive to manufacture. It is inherently reliable, and does not require extreme precision in manufacture.

Those skilled in the art of spring design will readily recognize that the resilient element 25 of the actuator 24 may be disposed at the exposed or actuator end 23 of the plunger 21, so that the resilient section acts as part of the push button and closes the actuator end of the valve body 13. However, this is not essential, and the resilient element 24 can be disposed within the valve body 13, at a location inaccessible to the user, as explained in detail above through use of push button element 60. In addition, although it is highly advantageous to form the resilient element integrally with the plunger member, this is not essential.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. In a dispensing valve for fluids of the type having
a valve body comprising:
a first elongate channel having a rigid exterior wall defining a generally annular passage extending from a fluid inlet end to an actuator end;
a fluid discharge outlet intermediate said inlet end and said actuator end, said discharge outlet comprising a wall defining an open face at one end thereof, and attached to said valve body at an opposite end thereof; and
a valve port wall intermediate said inlet end and said discharge outlet, said valve port wall defining a valve port; and
a resilient valve seal moveable from a closed position in which said valve seal occludes said valve port to an open position in which said valve seal does not occlude said valve port; and
a resilient actuator operatively connected to said resilient valve seal and operatively engaging said valve body so that said resilient actuator exerts a closing force on said resilient valve seal biasing said resilient valve seal towards said closed position; wherein the improvement comprises:
a shell having a wall defining an open face at one end thereof and attached to said valve body at an opposite end thereof, said shell extending around said fluid discharge outlet, and said open face of said shell being positioned a greater distance from said valve body than said open face of said discharge outlet;
a guide member aligned with a centrally located opening in said valve port wall and extending from said valve port wall in a direction toward said actuator end of said valve body; and
a support wall intermediate said actuator end and said discharge outlet and disposed between said guide member and an interior wall of said valve body
wherein a portion of the guide member combines with portions of the valve port wall and the support wall to form boundaries for the discharge outlet.

2. The dispensing valve of claim 1, wherein said valve body, said resilient valve seal, and said resilient actuator are formed from materials selected for their ability to withstand gamma and cobalt irradiation exposure of at least 5.0 MRAD.

3. The dispensing valve of claim 1, wherein the open face of the shell is substantially larger than the open face of the discharge outlet.

4. The dispensing valve of claim 1, further comprising:
a plunger member reciprocally mounted within said guide member and having an outer end and an inner end, said outer end being attached to said resilient actuator, and said inner end being attached to said resilient valve seal.

5. The dispensing valve of claim 4, further comprising:
means for arresting opening movement of said plunger member and said resilient valve seal when said plunger member and said resilient valve seal reach said open position.

6. The dispensing valve of claim 4, further comprising:
a stop element on said plunger member and a stop element on said guide member, said stop elements engaging one another so as to arrest opening movement of said plunger member and said resilient valve seal when said plunger member and said resilient valve seal reach said open position.

7. The dispensing valve of claim 4, wherein said outer end of said plunger member is exposed for manual engagement by a user to open said dispensing valve, and said resilient actuator forms at least part of a push button for manual engagement by the user.

8. The dispensing valve of claim 7, wherein said valve body has an opening at said actuator end, said push button substantially occluding said opening.

9. The dispensing valve of claim 1, further comprising:
a push button element exposed for manual engagement by a user to open said dispensing valve, said push button element being frictionally held by said resilient actuator.

10. The dispensing valve of claim 9, said push button element further comprising a generally planar disc having a top surface and a bottom surface, an engagement pin extending outward from said bottom surface, and a ring surrounding a portion of said engagement pin adjacent said bottom surface and defining a ledge generally parallel to said bottom surface.

11. The dispensing valve of claim 10, said pin being frictionally held within an opening in a top surface of said resilient actuator, and said ledge abutting said top surface of said resilient actuator adjacent said opening.

12. The dispensing valve of claim 9, said push button element further comprising a tamper indicating ring circumscribing said push button element and detachably affixed thereto.

13. The dispensing valve of claim 12, said tamper indicating ring comprising a plurality of tabs having a weakened portion detachably holding said tamper indicating ring to said push button element.

14. The dispensing valve of claim 1, wherein said shell and said discharge outlet are integrally connected with said body.

15. The dispensing valve of claim 1, wherein said discharge outlet forms a fluid discharge channel and said shell forms a channel at least partially surrounding said fluid discharge channel.

16. The dispensing valve of claim 19, wherein a sufficient distance is provided between an outer edge of said fluid discharge channel and an outer edge of said shell channel to prevent fluid transiting said valve from contacting said shell channel.
